(19) United States
(12) Patent Application Publication
(10) Pub. No.: US 2018/0365085 A1
(43) Pub. Date: Dec. 20, 2018

(54) METHOD AND APPARATUS FOR MONITORING CLIENT APPLICATIONS

(71) Applicant: ALIBABA GROUP HOLDING LIMITED, George Town (KY)

(72) Inventor: Julei LI, Hangzhou (CN)

(73) Assignee: ALIBABA GROUP HOLDING LIMITED

(21) Appl. No.: 16/119,899

(22) Filed: Aug. 31, 2018

Related U.S. Application Data
(63) Continuation of application No. PCT/CN2017/074167, filed on Feb. 20, 2017.

(30) Foreign Application Priority Data
Mar. 1, 2016 (CN) 201610115058.X

(51) Int. Cl. G06F 9/54; G06F 17/30

(52) U.S. Cl. CPC G06F 9/542; G06F 17/30424

(57) ABSTRACT

Embodiments of the disclosure provide methods and systems for monitoring client applications. The method can include: monitoring an event tracking log by calling an event tracking software development kit (SDK), wherein the event tracking log is created by a client application according to an event tracking attribute, and the client application predefines the event tracking attribute by calling an application programming interface (API) of the event tracking SDK; extracting event tracking information from the event tracking log; merging the event tracking information according to at least one dimension; and presenting the merged event tracking information according to a query request.

### CROSS REFERENCE TO RELATED APPLICATION

The disclosure claims the benefits of priority to International application number PCT/CN2017/074167, filed Feb. 20, 2017, and Chinese application number 201610115058.X, filed Mar. 1, 2016, both of which are incorporated herein by reference in their entireties.

### BACKGROUND

Technical solutions for information statistics of client applications generally state an Aspect Oriented Programming (AOP) interception by means of annotation using class methods or by means of a configuration file. An exemplary flowchart is as shown in FIG. 1. A client application can configure an agent through annotation or an AOP configuration file of Spring (an open framework). The agent can intercept an execution method of the client application. And after accessing the intercepted execution method that has been configured, the agent can record the accessed execution method and counts the number of times that the execution method has been intercepted.

In conventional methods for collecting information of a client application through agent-based interception, an object intercepted by an agent is customized in advance for a certain scenario and cannot be adjusted according to practice. In addition, the agent can intercept only an execution method of the client application but cannot intercept parameters or data related to the execution method. Therefore, the interception result obtained by the agent cannot be further utilized, leading to a low utilization rate of the agent interception result.

### SUMMARY OF THE DISCLOSURE

In view of the above problems, embodiments of the disclosure provide a cloud platform-based client application information statistical method and a corresponding cloud platform-based client application information statistical apparatus to overcome the above problems or at least partly solve the above problems.

Embodiments of the disclosure provide a method for performing information statistics on client applications. The method can include: monitoring an event tracking log by calling an event tracking software development kit (SDK), wherein the event tracking log is created by a client application according to an event tracking attribute, and the client application predefines the event tracking attribute by calling an application programming interface (API) of the event tracking SDK; extracting event tracking information from the event tracking log; merging the event tracking information according to at least one dimension; and presenting the merged event tracking information according to a query request.

Embodiments of the disclosure further provide an apparatus for performing information statistics on client applications. The apparatus can include: a memory storing a set of instruction; and a processor configured to execute the set of instructions to cause the apparatus to monitor an event tracking log by calling an event tracking software development kit (SDK), wherein the event tracking log is created by a client application according to an event tracking attribute, and the client application predefines the event tracking attribute by calling an application programming interface (API) of the event tracking SDK; extract event tracking information from the event tracking log; merge the event tracking information according to at least one dimension; and present the merged event tracking information according to a query request.

Embodiments of the disclosure further provide a non-transitory computer readable medium that stores a set of instructions that is executable by at least one processor of a computer system to cause the computer system to perform a method for performing information statistics on client applications. The method can include: monitoring an event tracking log by calling an event tracking software development kit (SDK), wherein the event tracking log is created by a client application according to an event tracking attribute, and the client application predefines the event tracking attribute by calling an application programming interface (API) of the event tracking SDK; extracting event tracking information from the event tracking log; merging the event tracking information according to at least one dimension; and presenting the merged event tracking information according to a query request.

### BRIEF DESCRIPTION OF THE DRAWINGS

FIG. 1 is a schematic flowchart of information statistics of a client application in the prior art;

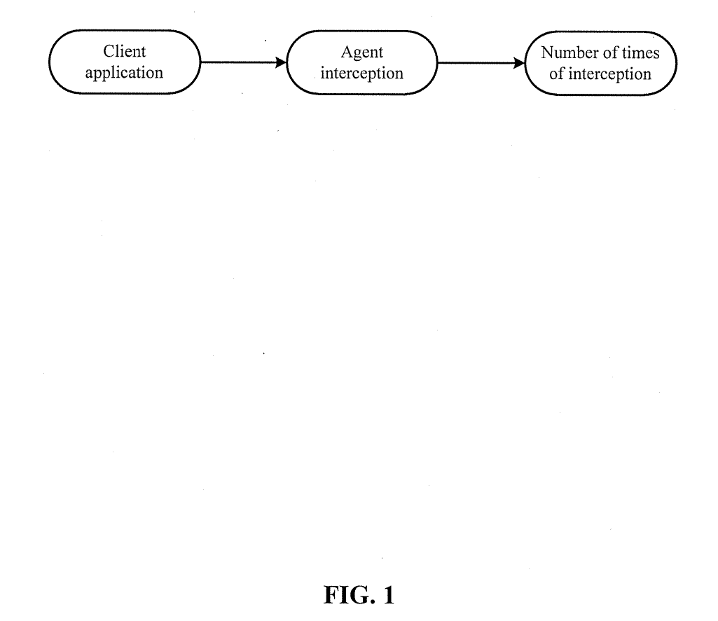

FIG. 2 is a flowchart of an exemplary cloud platform-based method for performing information statistics on client applications, according to embodiments of the disclosure.

FIG. 3 is a schematic diagram of an exemplary LogAgent in the method for performing information statistics on client applications, according to embodiments of the disclosure.

FIG. 4 is a schematic diagram of an exemplary merging system in the method for performing information statistics on client applications, according to embodiments of the disclosure.

FIG. 5 is a schematic diagram illustrating an exemplary relationship among a message oriented middleware, JStorm, and a merging system in the method for performing information statistics on client applications, according to embodiments of the disclosure.

FIG. 6 is a flowchart of another exemplary cloud platform-based method for performing information statistics on client applications, according to embodiments of the disclosure.

FIG. 7 is a schematic logical diagram of an exemplary cloud platform-based method for performing information statistics on client applications, according to embodiments of the disclosure.

FIG. 8 is a block diagram of an exemplary cloud platform-based device for performing information statistics on client applications, according to embodiments of the disclosure.

### DETAILED DESCRIPTION

To make the above objectives, features and advantages of the disclosure more comprehensible, the disclosure is described in further detail below with reference to the accompanying drawings and specific implementations.

Embodiments of the disclosure provide a cloud platform-based method for performing information statistics on client applications, which can be applied to a server terminal. The server terminal provides an event tracking Software Development Kit (SDK). The client application can call an application Programming Interface (API) in the event tracking SDK to configure an event tracking. The server terminal systematically monitors an event tracking log, collects the event tracking log by using an intelligent agent, automatically merges messages in the event tracking log in real time, and queries and presents the merging result. In this way, the information collection and statistics of the client application can be performed.

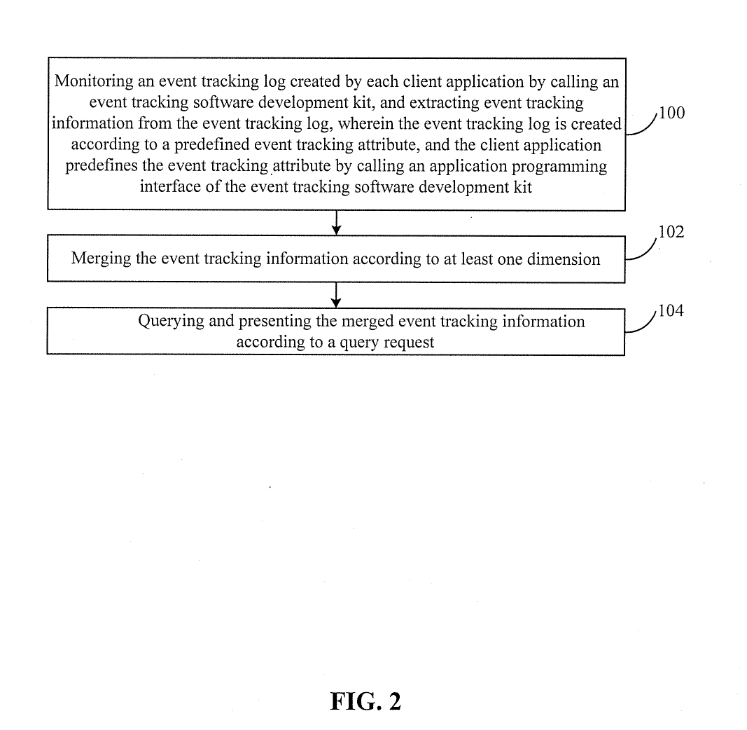

FIG. 2 is a flowchart of a cloud platform-based method for performing information statistics on client applications, according to embodiments of the disclosure. The method may specifically include steps 100-104.

In step 100, an event tracking log created by each client application can be monitored by calling an event tracking SDK, and event tracking information can be extracted from the event tracking log. The event tracking log can be created according to a predefined event tracking attribute, and the client application predefines the event tracking attribute by calling an application programming interface of the event tracking SDK.

The event tracking SDK is provided by the server terminal to the client application. The event tracking SDK can generate an event tracking log. The event tracking log is a log file used for recording collected event tracking information. For example, an event tracking attribute can be configured in the event tracking SDK. And by using the configured event tracking attribute, the event tracking SDK stores, into the event tracking log, event tracking messages related to the configured event tracking attribute during running of the client application.

The event tracking attribute may be predefined in the event tracking SDK or may be configured by using the client application. For example, the event tracking SDK may be provided in a form of a JAR package to the client application. A JAVA client application can rely on the JAR package of the event tracking SDK to configure event tracking. For example, the client application may access an application programming interface (API) provided in the event tracking SDK to configure the event tracking attribute used for creating the event tracking log, so as to collect event tracking information according to the event tracking attribute. Because data related to a client application can be collected in a manner configured according to user needs in different application scenarios, the information collecting range of the client application can be enlarged, and the utilization rate of the collection result can be improved.

In some embodiments, information such as the name and storage path of the event tracking log may be predefined by using the SDK.

The event tracking attribute may include at least one of an event tracking type or an event tracking keyword.

The event tracking attribute may include the event tracking type. For example, if a load test can be carried out for the client application deployed in the cloud platform and the user wants to know the load status of the entire cloud platform system under the client application, user queries may be performed by using a configured event tracking type, and each recorded user query may be acquired according to the event tracking type, so as to further determine a maximum queries per second (QPS) of the cloud platform system according to the user queries.

The event tracking type may also be classified. For example, the event tracking type may be classified as an event tracking category or an event tracking subcategory to which the event tracking information belongs. The event tracking category can be a parent category of the event tracking subcategory, and the event tracking subcategory can be a child category of the event tracking category. Therefore, classified statistics of the acquired event tracking information is implemented by using a parent-child relationship defined by the event tracking type. For example, during the analysis of multiple execution methods of a client application calling for a database, an event tracking category may be defined for the calling, and an event tracking subcategory may be defined for each execution method.

The event tracking attribute may include an event tracking keyword. The client application can define an event tracking keyword for the collection, and further acquire event tracking information related to the event tracking keyword. For example, when multiple running parameters of a client application need to be analyzed, event tracking keywords of the event tracking SDK may be defined respectively to distinguish the running parameters. The event tracking keyword may be defined together with the event tracking type. For example, a client application can be deployed on ten virtual machines in a cloud environment, and event tracking keywords of the event tracking SDK may be defined to distinguish running parameters such as CPU, memory, and disks of each virtual machine. In other words, an event tracking type is defined for each virtual machine, and event tracking keywords under the event tracking type are defined for running parameters of each virtual machine.

The event tracking attribute may further include call time consumption and a call success identifier for a target object, to respectively indicate time consumption for calling a target object (for example, an execution method) of the client application and whether the target object is successfully called. The call time consumption and the call success/failure information can be recorded in the event tracking log for analysis use.

In some embodiments, the name of an API can be logStat, and at least one of the event tracking type, the event tracking subcategory, the event tracking keyword, the call time consumption, or the call success/failure information can be defined. When the event tracking type and the event tracking subcategory are defined, the event tracking SDK records that the result is “logStat (String category, subCategory).” When the event tracking type, the event tracking subcategory, and the call time consumption are defined, the event tracking SDK records that the result is “logStat (String category, subCategory, Long response Time).” When the event tracking type, the event tracking keyword, the call time consumption and the call success/failure information are defined, the event tracking SDK records that the result is “logStat (String category, String keyWord, Long responseTime, Boolean success).”

Collection of parameters related to an execution method will be used as an example for description below. For example, the specific class of the API provided by SDK is “MonitorService,” the name of the API is “MonitorServicelogStat”, and operations in the client application are performed on a MySQL database, and methods are named as “insertMethod” and “updateMethod”. A number of calls per minute during running of the application can be determined for the two methods. When the event tracking SDK is used to record that the method has been called once, the category can be set to “MySQL” and the subCategories can be defined as “Insert” and “Update”. Examples below are described based on the event tracking of the method “insertMethod”.

If the call time consumption of the method does not need to be recorded, the event tracking SDK records the result as MonitorService.logStat(“MySQL”, “Insert”).

If the time consumption of the execution of insertMethod are recorded, the execution time of the method insertMethod can be obtained by subtracting the start time from the end time of the method insertMethod. Assuming the time consumption is 10 ms, the result recorded by the event tracking SDK is MonitorService.logStat(“MySQL”, “Insert”, “10”).

If whether the call is successful are recorded, the recorded result can be MonitorService.logStat(“MySQL”, “Insert”, “10”, “true”) indicating call success, or MonitorService.logStat(“MySQL”, “Insert”, “0”, “false”) indicating call failure. This also applies to event tracking of updateMethod.

Monitoring the event tracking log may be monitoring a change in the event tracking log to find new event tracking information. For an event tracking log having a log catalog, a change in the catalog of the event tracking log may be monitored. When the catalog changes, it is determined that new event tracking information is added. Alternatively, a change in the event tracking information can be monitored, and when the event tracking information changes, it is determined that new event tracking information is added. The two methods may be used in combination for monitoring.

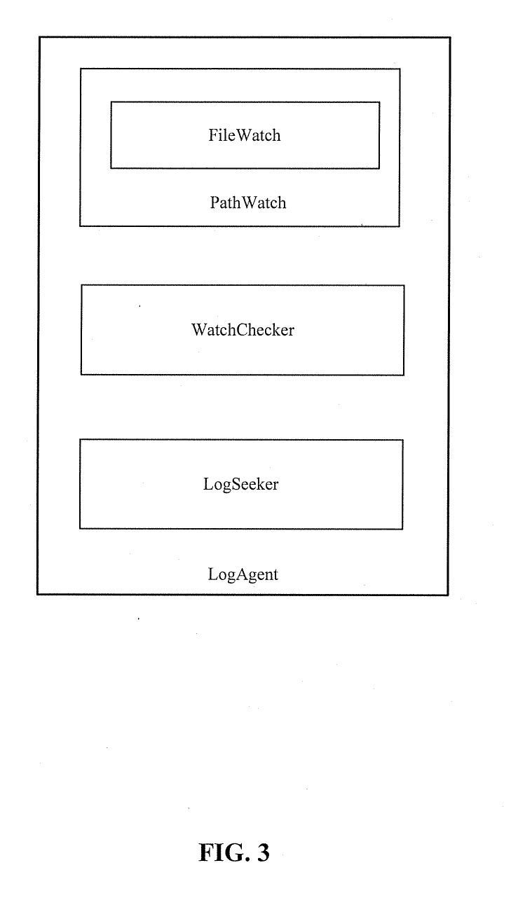

Step 100 may use LogAgent to monitor the event tracking log. LogAgent can be configured to monitor the event tracking log, and may include the following modules: a PathWatch module, a FileWatch module, a WatchChecker module, and a LogSeeker module. The PathWatch module can be configured to monitor the change in the catalog of the event tracking log. The FileWatch module can be configured to monitor the change in the event tracking information of the event tracking log. The WatchChecker module can be configured to set a limit on the number of pieces of event tracking information monitored in the event tracking log. The LogSeeker module can be configured to incrementally read the event tracking information from the event tracking log. For example, monitoring the event tracking log by using LogAgent may include monitoring a change state of the catalog of the event tracking log by using PathWatch. If the catalog changes, it indicates that new event tracking information is added to the event tracking log. Monitoring the event tracking log not only includes monitoring the catalog of the event tracking log, but also includes monitoring the event tracking information in the event tracking log by using the FileWatch module on the basis of monitoring the change state of the catalog of the event tracking log by using the PathWatch module. In the monitoring process, the WatchChecker module may further be used to set a limit on the number of pieces of event tracking information monitored. After the FileWatch module detects a change in the event tracking information in the event tracking log, the LogSeeker module is used to incrementally read the event tracking information. A schematic structural diagram of LogAgent is as shown in FIG. 3.

In step 100, reading the event tracking information from the event tracking log may be incrementally extracting the event tracking information from the event tracking log. For example, the event tracking log (e.g., xx.log file) may sequentially arrange pieces of event tracking information in segments. When a segment of content is added to the event tracking log, it is considered that a piece of event tracking information is added. When the event tracking information is read, the event tracking information that has already been read can be ignored, and only the newly added event tracking information can be read. Because the entire event tracking log may not be read, the amount of data to be processed can be reduced.

In some embodiments of the disclosure, after the event tracking information is read from the event tracking log in step 100, the read event tracking information may further be sent to the message oriented middleware. The message oriented middleware may be a queuing model message oriented middleware (e.g., MetaQ) or a distributed subscription message publishing system (e.g., kafka). The message oriented middleware can be configured to transmit the event tracking information, and control the transmission rate of the event tracking information by using a message stacking function of the message oriented middleware. Correspondingly, before the event tracking information is processed, the event tracking information can be extracted from the message oriented middleware.

In step 102, the event tracking information can be merged according to at least one dimension. After the event tracking information is obtained, the event tracking information may be merged according to at least one dimension. Thus, classified statistics of the collection result of the client application can be implemented. For example, the event tracking information is merged according to an application dimension and a time dimension to finally provide merged information of a client application with a smallest granularity of 1 minute, that is, merged information of a client application with the smallest unit in the time dimension being 1 minute.

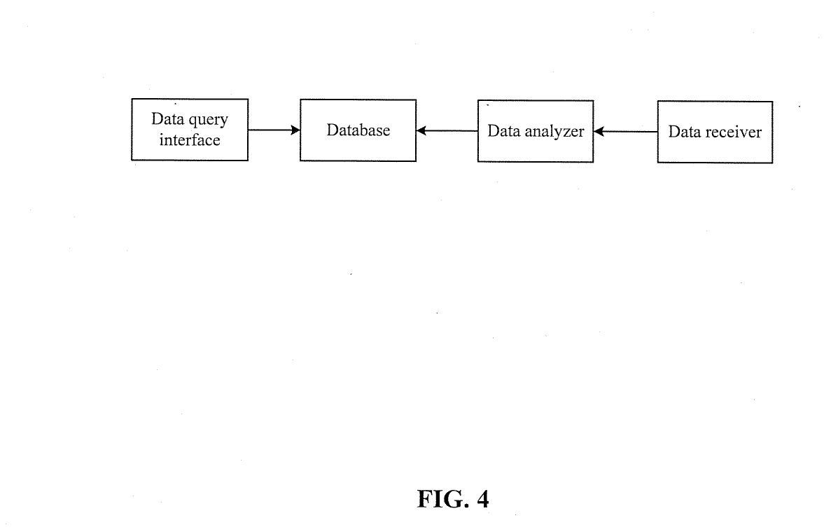

A merging system for merging the event tracking information in the event tracking log may be deployed in the server terminal. The operation of merging the event tracking information may be executed in the merging system. An exemplary structure of the merging system is as shown in FIG. 4. The merging system may use a data receiver to receive merged information, use a data analyzer to analyze the merged information, and store the merged information to a database. The database can be configured to store the analyzed merged information and may further provides a data query interface for querying merged information. The use of the merging system to merge the data can ensuring the real-timeliness and accuracy of data processing.

Merging the event tracking information according to the time dimension may include merging multiple pieces of event tracking information belonging to a same time point or a same period of time according to a time point or time period corresponding to each piece of event tracking information, to serve as merged data at the same time point or within the same period of time. Multiple pieces of event tracking information belonging to the same client application can be merged according to an identifier of a client application corresponding to each piece of event tracking information, to serve as merged information of the same client application. The multiple pieces of event tracking information may include event tracking information of the same client application or different client applications.

The event tracking log also includes some redundant information in addition to the useful event tracking information. Therefore, in some embodiments of the disclosure, before step 102, the read event tracking information may further be cleaned and filtered. Some meaningless characters or signs (e.g., separators) can be deleted by cleaning, and useful event tracking information can be extracted from the remaining information by filtering. For example, screening may be performed according to at least one of the event tracking type or the event tracking keyword in the event tracking attribute.

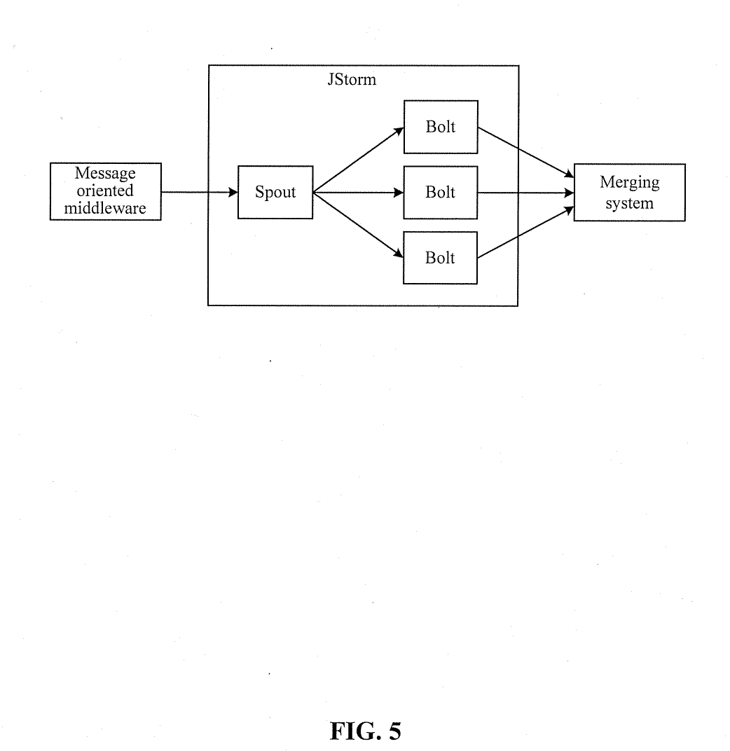

In some embodiments, a real-time computing framework may be used to read the event tracking information and filter the event tracking information. For example, a JStorm real-time computing framework may be used. JStorm can be used to extract event tracking information corresponding to the event tracking attribute. JStorm is a real-time computing framework developed by making continuous improvements on Storm in network input/output, thread model, resource scheduling, applicability and stability, and has such advantages as higher running stability, more powerful scheduling function and higher execution efficiency over Storm. As shown in FIG. 5, a schematic diagram illustrating the relationship among a message oriented middleware, JStorm, and a merging system is shown. JStorm acquires event tracking information from the message oriented middleware. JStorm cleans the event tracking information using Spout and filters the event tracking information using bolt, and sends the filtered event tracking information corresponding to the event tracking keyword to the merging system.

In step 104, the merged event tracking information can be queried and presented according to a query request. The server terminal may provide an interface for the user to query the event tracking information. For example, the above merging system may provide an interface. The user may access the interface to send a query request for event tracking information. After receiving the query request, the server terminal queries the required event tracking information and presents same to the user.

In some embodiments, the user may access the interface to input a query parameter representing required information. The server terminal can receive a query request carrying the query parameter, and further query corresponding event tracking information according to the query parameter. The query parameter may include at least one of a time period, the event tracking attribute, or an application identifier of the client application. For example, the query parameter can include the time period, the event tracking attribute, and the application identifier. And according to the query parameter, event tracking information corresponding to a certain keyword of a certain application within a certain time period can be queried in the merging system. The query result may be presented in various forms, such as graph, document, and trend chart. For example, a visual curve may be generated for event tracking information that is merged according to the time dimension, and the curve may be updated according to new event tracking data acquired in real time.

Thus, according to embodiments of the disclosure, an event tracking log created by a client application by calling an API in an event tracking SDK can be monitored, the event tracking information can be read from the event tracking log, and event tracking information merged according to different dimensions can be queried and presented according to a user's query request. In some embodiments, event tracking can be configured by using an API in an event tracking SDK. Because data related to a client application can be collected in a manner configured according to user needs in different application scenarios, the information collecting range of the client application can be enlarged, and the utilization rate of the collection result can be improved. In addition, the event tracking information read from the event tracking log is merged according to different dimensions, thus achieving classified statistics of the collection result of the client application. Moreover, the use of the message oriented middleware to transmit the event tracking information and control the transmission rate can alleviate the load of the merging system.

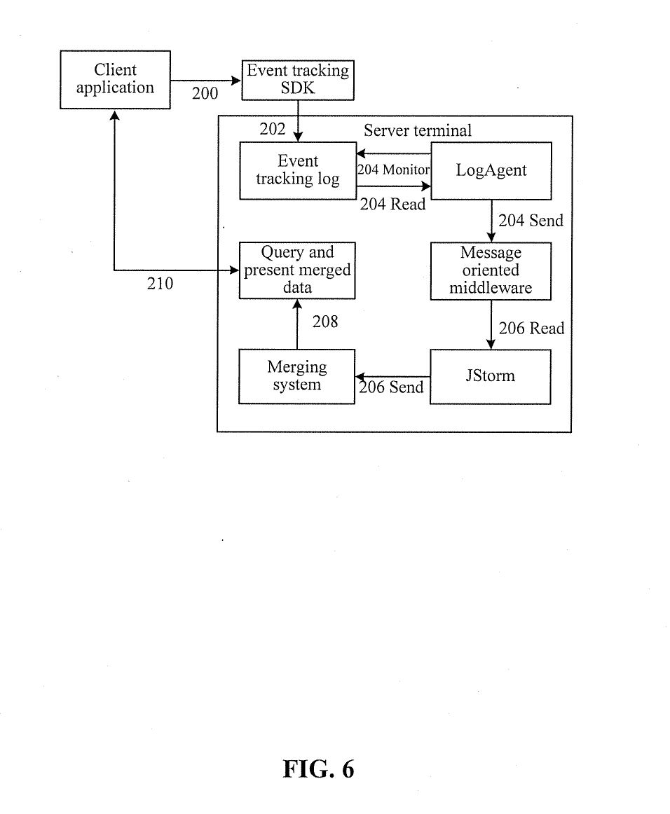

FIG. 6 is a flowchart of another cloud platform-based method for performing information statistics on client applications, according to embodiments of the disclosure. The method may include steps 200-210.

In step 200, a client application calls an event tracking SDK provided by a server terminal to configure event tracking.

In step 202, the event tracking SDK creates an event tracking log.

In step 204, LogAgent monitors the event tracking log, incrementally reads event tracking information from the event tracking log and sends the event tracking information to a message oriented middleware.

In step 206, JStorm reads the event tracking information from the message oriented middleware, performs real-time computing on the event tracking information, and sends the computed event tracking information to a merging system.

In step 208, the merging system merges the event tracking information according to at least one of an application dimension or a time dimension.

In step 210, the server terminal queries and presents the merged event tracking information according to a query request.

The client application according to embodiments of the disclosure can configure event tracking by using an API in an event tracking SDK. Because data related to a client application can be collected in a configured manner according to user needs in different application scenarios, the information collecting range of the client application can be enlarged, and the utilization rate of the collection result can be improved. In addition, the event tracking information read from the event tracking log is merged according to different dimensions, thus achieving classified statistics of the collection result of the client application.

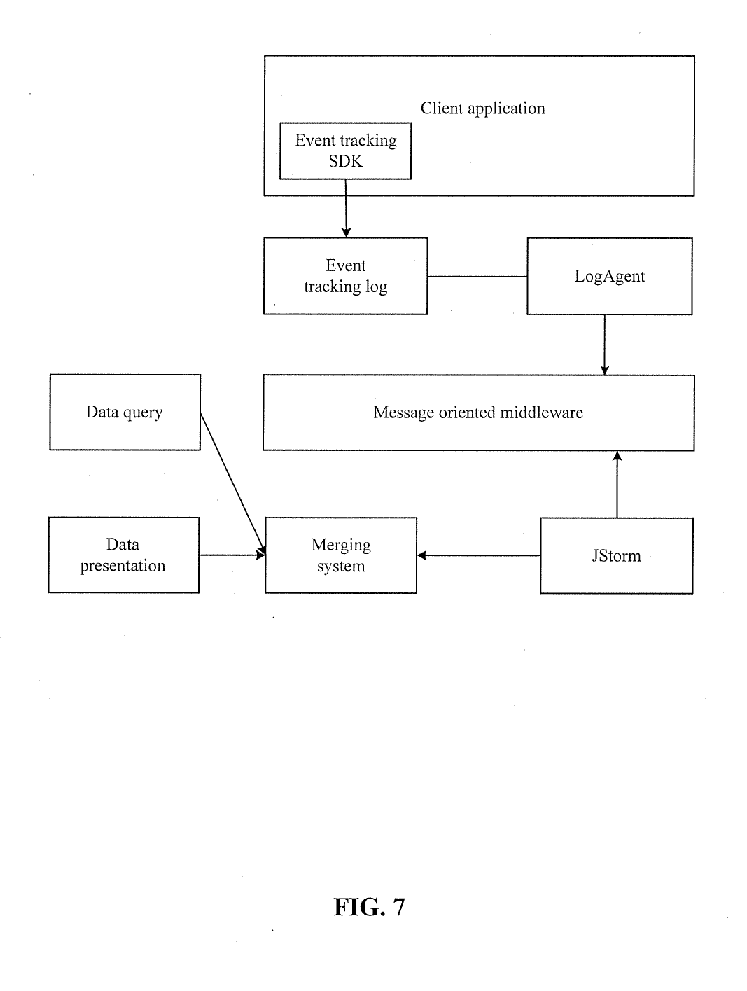

FIG. 7 is a schematic logical diagram of a cloud platform-based method for performing information statistics on client applications, according to embodiments of the disclosure. A client application calls an API in an event tracking SDK to configure event tracking, and an event tracking log is created; LogAgent reads event tracking information from the event tracking log and sends same to a message oriented middleware; JStorm reads in real time the event tracking information from the message oriented middleware, performs cleaning and filtering, and sends the cleaned and filtered event tracking information to a merging system; the merging system merges the received event tracking information according to at least one dimension, and provides a data query function and a data presentation function externally.

Thus, an event tracking log created by a client application by calling an API in an event tracking SDK can be monitored, the event tracking information can be read from the event tracking log, and event tracking information merged according to different dimensions can be queried and presented according to a user's query request. In embodiments of the disclosure, event tracking can be configured by using an API in an event tracking SDK. And because data related to a client application can be collected in a configured manner according to user needs in different application scenarios, the information collecting range of the client application can be enlarged, and the utilization rate of the collection result can be improved. In addition, the event tracking information read from the event tracking log can be merged according to different dimensions, thus achieving classified statistics of the collection result of the client application.

It should be noted that for simplicity, the method embodiment are described as a series of action combinations, but it should be understood by those skilled in the art that the embodiments of the disclosure are not limited to the described order of actions, because some steps may be performed in a different order or simultaneously according to the embodiments of the disclosure. It should also be understood by those skilled in the art that the embodiments described in the specification are all preferred embodiments, and the actions involved in these embodiments may not be necessary for the embodiments of the disclosure.

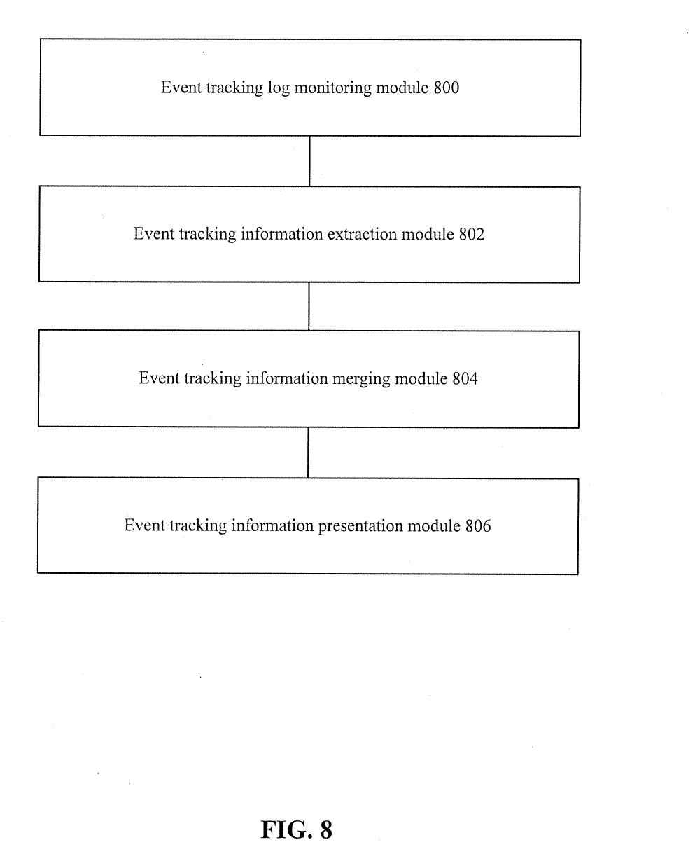

FIG. 8 is a block diagram of a cloud platform-based device for performing information statistics on client applications, according to embodiments of the disclosure. The apparatus may include modules 800-806.

An event tracking log monitoring module 800 can be configured to monitor an event tracking log created by each client application by calling an event tracking SDK.

An event tracking information extraction module 802 can be configured to extract event tracking information from the event tracking log, wherein the event tracking log is created according to a predefined event tracking attribute, and the client application predefines the event tracking attribute by calling an application programming interface of the event tracking SDK.

An event tracking information merging module 804 can be configured to merge the event tracking information according to at least one dimension.

An event tracking information presentation module 806 can be configured to query and present the merged event tracking information according to a query request.

In embodiments of the disclosure, the event tracking attribute can include at least one of an event tracking type and an event tracking keyword of the event tracking information, and the event tracking type includes an event tracking category or an event tracking subcategory to which the event tracking information belongs.

In embodiments of the disclosure, the event tracking log monitoring module can be configured to monitor a change state of a catalog of the at least one of the event tracking log and the event tracking information; and if the at least one of the catalog or the event tracking information changes, determine that new event tracking information is added to the event tracking log.

In embodiments of the disclosure, the event tracking information reading module can be configured to incrementally extract the event tracking information from the event tracking log.

In embodiments of the disclosure, the device further includes: an event tracking information sending module, configured to send the event tracking information to a message oriented middleware after the event tracking information is extracted from the event tracking log, wherein the message oriented middleware is configured to transmit the event tracking information and control a transmission rate.

The device can further include: an event tracking information extraction module, configured to read the event tracking information from the message oriented middleware before the event tracking information is merged according to the at least one dimension.

In embodiments of the disclosure, the device can further include: an event tracking information screening module, configured to find event tracking information corresponding to the event tracking attribute through screening before the event tracking information is merged according to the at least one dimension.

In embodiments of the disclosure, the event tracking information merging module can be configured to merge the event tracking information according to at least one of an application dimension or a time dimension.

In embodiments of the disclosure, the query request can carry a query parameter input through a query interface. And the event tracking information presentation module can be configured to query and present the merged event tracking information according to the query parameter, wherein the query parameter includes at least one of a time period, the event tracking attribute, and an application identifier of the client application.

Thus, in embodiments of the disclosure, an event tracking log created by a client application by calling an API in an event tracking SDK can be monitored, the event tracking information can be read from the event tracking log, and event tracking information merged according to different dimensions can be queried and presented according to a user's query request. In embodiments of the disclosure, event tracking can be configured by using an API in an event tracking SDK. Because data related to a client application can be collected in a configured manner according to user needs in different application scenarios, the information collecting range of the client application can be enlarged, and the utilization rate of the collection result can be improved. In addition, the event tracking information read from the event tracking log can be merged according to different dimensions, thus achieving classified statistics of the collection result of the client application.

The apparatus embodiment provides functionality that is basically similar to the functionality of the method embodiment and therefore is described briefly, and for the relevant part, reference may be made to the part of the description of the method embodiment.

Embodiments in the specification are described in a progressive manner. For same or similar parts in the embodiments, reference may be made to each other.

As will be appreciated by those skilled in the art, the embodiments of the disclosure may be embodied as a method, a system, or a computer program product. Accordingly, the disclosure may use the form of an entirely hardware embodiment, an entirely software embodiment or an embodiment combining software and hardware aspects. Furthermore, the embodiments of the disclosure may use the form of a computer program product implemented on one or more computer-usable storage media (including but not limited to magnetic disk memories, CD-ROMs, optical memories, etc.) including computer-usable program code.

In a typical configuration, a computation device includes one or more central processing units (CPUs), input/output interfaces, network interfaces, and memories. The memory may include the following forms of a computer readable medium: a volatile memory, a random access memory (RAM) and/or a non-volatile memory, for example, a read-only memory (ROM) or flash RAM. The memory is an example of the computer readable medium. The computer readable medium includes volatile and non-volatile, mobile and non-mobile media, and can use any method or technology to store information. The information may be a computer readable instruction, a data structure, a module of a program or other data. Examples of storage media of the computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be used for storing computer accessible information. According to the definition herein, the computer readable medium does not include transitory computer readable media (transitory media), for example, a modulated data signal and carrier.

Embodiments of the disclosure are described with reference to flowcharts and/or block diagrams of the method, terminal device (system) and computer program product in the embodiments of the disclosure. It should be understood that computer program instructions can implement each process and/or block in the flowcharts and/or block diagrams and a combination of processes and/or blocks in the flowcharts and/or block diagrams. These computer program instructions may be provided to a computer, an embedded processor or a processor of another programmable data processing device to generate a machine, so that an apparatus configured to implement functions specified in one or more processes in the flowcharts and/or one or more blocks in the block diagrams is generated by using instructions executed by the computer or the processor of another programmable data processing device.

These computer program instructions may also be stored in a computer readable memory that can guide a computer or another programmable data processing device to work in a specified manner, so that the instructions stored in the computer readable memory generate a product including an instruction apparatus, where the instruction apparatus implements functions specified in one or more processes in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flowcharts and/or one or more blocks in the block diagrams.

Although embodiments of the present invention have been described, it is appreciated that additional variations or modifications can be made to the embodiments after learning the basic inventive concept. Therefore, the appended claims should be construed as including the preferred embodiments and all variations and modifications that fall within the scope of the embodiments of the present disclosure.

Finally, it should be further noted that as used herein, relational terms such as first and second are merely used for distinguishing one entity or operation from another entity or operation, and do not necessarily require or imply any actual relationship or sequence between entities or operations. In addition, the terms “include”, “comprise” or any other variation thereof, are intended to cover a non-exclusive inclusion, such that a process, method, article, or device that includes a list of elements does not include only those elements but may include other elements not expressly listed or inherent to such process, method, article, or device. An element proceeded by “a”, “an”, or the like does not, without more constraints, preclude the existence of additional identical elements in the process, method, article, or device that includes the element.

The cloud platform-based client application information statistical method and apparatus provided by the disclosure are described in detail above. Examples are used in the specification to elaborate the principle and implementation of the disclosure. However, the descriptions of the foregoing embodiments are merely used to facilitate the understanding of the method and core idea of the disclosure. Modifications can be made to the specific implementation and the application scope according to the idea of the disclosure. Therefore, the content of the specification should not be construed as limiting the disclosure.

1. A method for monitoring client applications, comprising:
monitoring an event tracking log by calling an event tracking software development kit (SDK), wherein the event tracking log is created by a client application according to an event tracking attribute, and the client application predefines the event tracking attribute by calling an application programming interface (API) of the event tracking SDK;
extracting event tracking information from the event tracking log;
merging the event tracking information according to at least one dimension; and
presenting the merged event tracking information according to a query request.

2. The method according to claim 1, wherein the event tracking attribute includes at least one of an event tracking type or an event tracking keyword of the event tracking information, and the event tracking type includes an event tracking category or an event tracking subcategory to which the event tracking information belongs.

3. The method according to claim 1, wherein monitoring the event tracking log by calling the event tracking SDK includes:
monitoring a change of the event tracking information; and
in response to the change of the event tracking information, determining that new event tracking information is added to the event tracking log.

4. The method according to claim 1, wherein extracting the event tracking information from the event tracking log includes:
incrementally extracting the event tracking information from the event tracking log.

5. The method according to claim 1, wherein after extracting the event tracking information from the event tracking log, the method further includes:
storing the event tracking information into a message oriented middleware, wherein the message oriented middleware is configured to transmit the event tracking information and control a transmission rate; and
receiving the event tracking information from the message oriented middleware.

6. The method according to claim 1, wherein before merging the event tracking information according to at least one dimension, the method further includes:
determining the event tracking information corresponding to the event tracking attribute through screening.

7. The method according to claim 1, wherein merging the event tracking information according to at least one dimension further includes:
merging the event tracking information according to an application dimension or a time dimension.

8. The method according to claim 1, wherein the query request carries a query parameter input through a query interface, and the query parameter includes at least one of a time period, the event tracking attribute, or an application identifier of the client application.

9. An apparatus for monitoring client applications, comprising:
a memory storing a set of instruction; and
a processor configured to execute the set of instructions to cause the apparatus to
monitor an event tracking log by calling an event tracking software development kit (SDK), wherein the event tracking log is created by a client application according to an event tracking attribute, and the client application predefines the event tracking attribute by calling an application programming interface (API) of the event tracking SDK;
extract event tracking information from the event tracking log;
merge the event tracking information according to at least one dimension; and
present the merged event tracking information according to a query request.

10-16. (canceled)

17. A non-transitory computer readable medium that stores a set of instructions that is executable by at least one processor of a computer system to cause the computer system to perform a method for monitoring client applications, the method comprising:
monitoring an event tracking log by calling an event tracking software development kit (SDK), wherein the event tracking log is created by a client application according to an event tracking attribute, and the client application predefines the event tracking attribute by calling an application programming interface (API) of the event tracking SDK;
extracting event tracking information from the event tracking log;
merging the event tracking information according to at least one dimension; and
presenting the merged event tracking information according to a query request.

18. The non-transitory computer readable medium according to claim 17, wherein the event tracking attribute includes at least one of an event tracking type or an event tracking keyword of the event tracking information, and the event tracking type includes an event tracking category or an event tracking subcategory to which the event tracking information belongs.

19. The non-transitory computer readable medium according to claim 17, wherein monitoring the event tracking log by calling the event tracking SDK includes:
monitoring a change of the event tracking information; and
in response to the change of the event tracking information, determining that new event tracking information is added to the event tracking log.

20. The non-transitory computer readable medium according to claim 17, wherein extracting the event tracking information from the event tracking log includes:
incrementally extracting the event tracking information from the event tracking log.

21. The non-transitory computer readable medium according to claim 17, wherein after extracting the event tracking information from the event tracking log, the set of instruction is further executed to cause the computer system to:
store the event tracking information into a message oriented middleware, wherein the message oriented middleware is configured to transmit the event tracking information and control a transmission rate; and
receive the event tracking information from the message oriented middleware.

22. The non-transitory computer readable medium according to claim 17, wherein before merging the event tracking information according to at least one dimension, the set of instruction is further executed to cause the computer system to:
determine the event tracking information corresponding to the event tracking attribute through screening.

23. The non-transitory computer readable medium according to claim 17, wherein merging the event tracking information according to at least one dimension further includes:
merging the event tracking information according to an application dimension or a time dimension.

24. The non-transitory computer readable medium according to claim 17, wherein the query request carries a query parameter input through a query interface, and the query parameter includes at least one of a time period, the event tracking attribute, or an application identifier of the client application.
